(19) United States
(12) Patent Application Publication
(10) Pub. No.: US 2024/0046315 A1
(43) Pub. Date: Feb. 8, 2024

(54) AD PROXY SERVICE

(71) Applicant: Atmosphere.tv, Austin, TX (US)

(72) Inventors: Zach Hobbs, Austin, TX (US); Jeff DiTullio, Austin, TX (US); Michael W. Santa Cruz, Eagle, ID (US); Alen Durbuzovic, Austin, TX (US); Eric Spielman, Rancho Santa Fe (UA); Brent Alan Hays, Austin, TX (US); Khai Thien Tran, Pflugerville, TX (US)

(21) Appl. No.: 17/882,321

(22) Filed: Aug. 5, 2022

(51) Int. Cl. G06Q 30/02

(52) U.S. Cl. CPC G06Q 30/0272; G06Q 30/0275

(57) ABSTRACT

Systems and methods are disclosed for implementing an ad proxy service. In certain embodiments, a method may comprise performing an ad proxy service at an ad proxy server, including receiving a prepare request, from a client device, to prepare an advertisement for display during an ad break in content playing at the client device; obtaining client metadata regarding the client device; negotiating the advertisement with an ad server by obtaining ad metadata; and providing the ad metadata to the client device.

### SUMMARY

In certain embodiments, a method may comprise performing an ad proxy service at an ad proxy server, including receiving a prepare request, from a client device, to prepare an advertisement for display during an ad break in content playing at the client device; obtaining client metadata regarding the client device; negotiating the advertisement with an ad server by obtaining ad metadata; and providing the ad metadata to the client device.

In certain embodiments, a system may comprise an ad proxy server configured to perform an ad proxy service, including receive a prepare request, from a client device, to prepare an advertisement for display during an ad break in content playing at the client device; obtain client metadata regarding the client device; negotiate the advertisement with an ad server by obtaining ad metadata; and provide the ad metadata to the client device.

In certain embodiments, a memory device may store instructions that, when executed, cause a processor to perform a method comprising obtaining, at a client device from an ad proxy service, an advertisement for display during an ad break in content playing at the client device, including obtaining ad configuration information regarding the content, and sending a prepare request to the ad proxy service at a first time prior to the ad break, the prepare request directing the ad proxy service to prepare the advertisement. The method may further comprise sending a fetch request to the ad proxy service at a second time prior to the ad break, the fetch request directing the ad proxy service to provide ad metadata corresponding to the advertisement to the client device; obtaining the advertisement based on the ad metadata; and displaying the advertisement during the ad break.

### BRIEF DESCRIPTION OF THE DRAWINGS

FIG. 1 is a diagram of a system configured to implement an ad proxy service, in accordance with certain embodiments of the present disclosure;

FIG. 2 is a process flow diagram of a system configured to implement an ad proxy service, in accordance with certain embodiments of the present disclosure;

FIG. 3 is a flowchart of an example method for implementing an ad proxy service, in accordance with certain embodiments of the present disclosure;

FIG. 4 is a flowchart of an example method for implementing an ad proxy service, in accordance with certain embodiments of the present disclosure; and

FIG. 5 is a diagram of a system configured to implement an ad proxy service, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

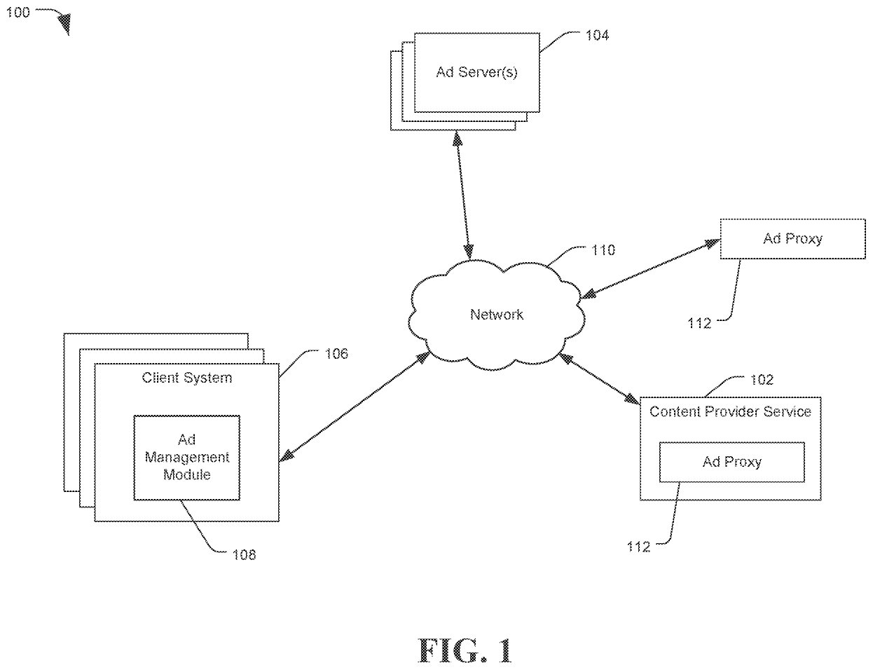

FIG. 1 depicts a diagram of a system 100 configured to implement an ad proxy service, in accordance with certain embodiments of the present disclosure. The system may include a content provider service (CPS) 102, one or more ad servers 104, one or more client systems 106, an ad proxy 112, and one or more networks 110 over which the components of system 100 may communicate and exchange data. Each or any of CPS 102, ad server 104, client system 106, ad proxy 112, and network 110 may be implemented via computers, servers, hardware and software modules, or other system components. Elements of system 100 may also include or have access to one or more data storage devices, data storage mediums, data storage servers, and related data structures such as databases, which may store data files and related metadata, streaming content data, advertisements, resource libraries or executable code, or other information.

Client systems or client devices 106, such as computers, smartphones, set-top boxes, or televisions or other display devices, may be used to play media content, such as over-the-top (OTT) media streamed or broadcast over the internet, or video on demand (VOD) media. The media content may include video or audio content, and may be streamed (e.g., via an HTTP live-stream, HLS) or downloaded as a content file (e.g., an MP4 video file). Some media may be provided with advertising or advertising breaks. Advertising may be added to media content using server-side ad insertion (SSAI) or client-side ad insertion (CSAI).

SSAI may include inserting or “stitching” advertising directly into the media content at a remote server, prior to providing the combined media and advertising to the client systems 106. SSAI may provide limited or prohibitively expensive or complex capability to tailor the advertising to particular clients, because combined media and advertising streams may be generated and provided to large groups of clients. Without generating a customized stream for every client system 106 at the media server, SSAI provides limited flexibility in adapting the advertising based on a variety of factors.

CSAI may operate by having the client system 106 make calls to an ad server 104 that responds with the ad, and the client system 106 can insert the received ads into ad breaks of media content. As CSAI may be handled by each individual client system 106, it may allow for more tailored or dynamic advertising. However, the complexity of managing the logic to determine how many ads to play, and which ads, from which ad provider, as well as other considerations, may limit the scalability of the CSAI approach. For example, the providers of client systems 106 may want to keep the devices as simple as possible to reduce costs and potential errors, and may want to avoid pushing software updates to client systems 106 that may interrupt a customer's ability to use the device.

As an example, client system 106 may include a connected TV (CTV) receiving media content over network 110 (such as the internet) from a content provider service 102. The client system 106 may be set up in a private location such as a home, or a public venue such as a bar, club, or store. Considerations that may be considered when selecting advertising may include a target number of ads per ad break (which may be a variable number such as 2.7, that may result in two ads 30% of the time and three ads 70% of the time), with a number of ads changing depending on the time of day or how busy the venue is expected to be. The type or content of ads may be selected based on a geographic location of the venue, what type of venue it is, what time of day it is, what content channel the client device 106 is set to, or a host of other potential factors. The client device 106 may have metadata for some of these factors stored locally. Another consideration may include avoiding using a same advertisement too frequently. Further, advertisements may be provided from a plurality of ad servers 104. Advertisers may “bid” on an advertising slot in real time through the ad servers, but some ad servers may not be configured to bid against each other or be accessed in the same manner, and so a pattern of how and when to “offer” a bidding opportunity to different ad servers 104 may need to be considered. For example, there may be different ad servers 104 for digital out-of-home (DOOH) advertising and CTV/OOT advertising, with different advertisers or different bidding pool funding for each set. DOOH may be advertising intended to reach audiences when they are out in public, while CTV/OOT advertising may be designed to reach customers via internet media broadcasting. In the example of a CTV in a public venue, both advertising pools are appropriate, but the different ad servers may each need to be given separate opportunities to bid on advertising slots.

Because of the potential complexity in scaling up advertising flexibility and customization for client systems 106, it may be advantageous to position significant amounts of ad selection and gathering logic at a system remote from the client systems 106. Accordingly, an advertising proxy service or system 112 is provided. Client devices 106 may include an ad management module 108 configured to access the ad proxy 112 (e.g., via a Restful application program interface, API) when an advertisement break is pending in a media content stream or file. The ad proxy 112 may generate ad break metadata and perform the complex ad selection and negotiation process for each client system 106, and report the results to the ad management module 108. The client system 106, via the ad management module 108, may then simply retrieve the selected advertisements from the appropriate ad servers 104 for display during the ad break in the media content.

The ad proxy 112 may be a stand-alone system or service, or it may be incorporated into or managed by a content provider service 102 that is also providing the media content to the client system 106. The ad proxy 112 may communicate with client system 106, content provider service 102, or ad server 104 via network 110. The ad proxy 112 may receive instructions from client 106 to prepare an ad break, and may receive metadata about client system 106, or an associated customer or account, from client system 106, content provider service 102, other sources, or a combination thereof. Based on default configurations, the metadata, or both, the ad proxy 112 may be configured to make a determination about how many ads to prepare, what type of ads, and from what ad servers 104. The ad proxy 112 may negotiate with ad servers 104 in a selected priority, and may obtain metadata for a selection of advertisements to play during the client system's ad break. The metadata may be provided in a data format such as VAST (video ad serving template), and may include addressing or access information that the client device 106 may use to retrieve the actual ad content (e.g., a video file), as well as information about proof of play tracking, creative or campaign identifiers associated with ads, or other related information. The metadata for the selected list of ads may be stored to a data structure of the ad proxy 112, such as to a Redis (remote dictionary server) data store. The client system 106 may then retrieve the ad metadata list, and use it to download or retrieve the selected advertisements (e.g., from ad servers 104), and present the ads during the media content ad break. The client system 106 may note proof of play tracking events (e.g., a percentage of the ad that has been played as it is presented), and relay the proof to the ad servers 104, the ad proxy 112, or any other appropriate system or entity.

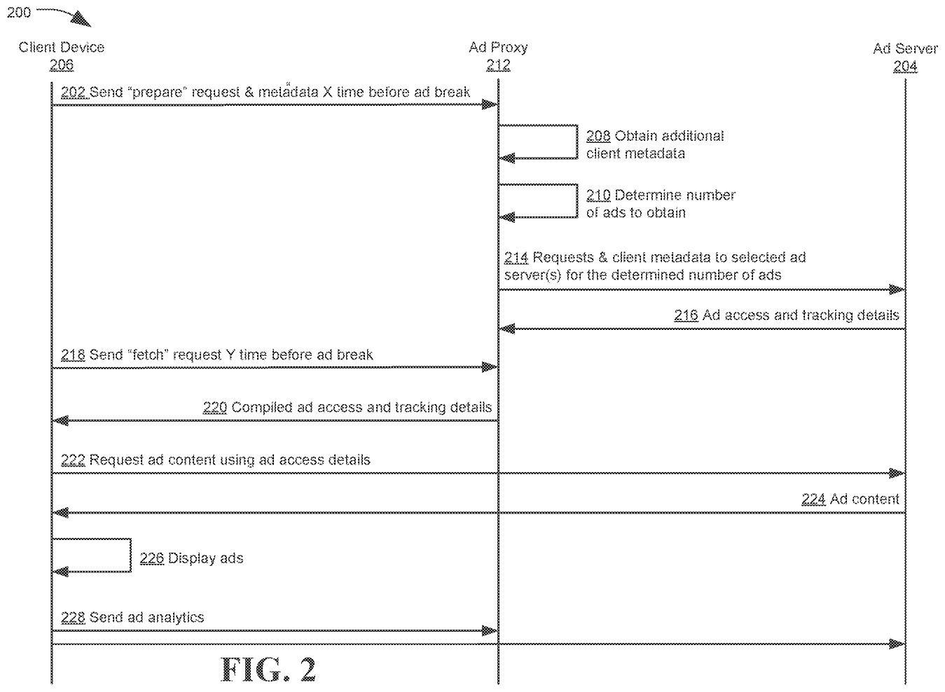

The ad servers 104 may include one or more systems through which advertisers can provide advertisements and bid on advertising opportunities or slots. For example, an ad server 104 may include a supply-side or sell-side platform (SSP) used to coordinate and manage the supply and distribution of ad inventories. An ad server 104 may also be a system or service to mediate for multiple SSPs, each of which may be affiliated with multiple advertisers, with different ad servers 104 managing SSPs for different advertising categories (e.g., DOOH, or CTV/OOT). An ad server 104 may also be configured to store and provide collections of “house” advertisements associated with a particular client system 106. For example, if client system 106 is a CTV set up at a bar, the bar may have its own advertisements for happy hour, live music events, or similar ads, which may be inserted in the ad breaks of the media content. Ad servers 104, such as for house ads, may be associated with or managed by content provider service 102, which may store metadata, ads, and client details for each client system 106, used in managing and customizing the media content provided to the client system. An example system and process for implementing an ad proxy system is described in further detail in regard to FIG. 2.

FIG. 2 depicts a process flow diagram of a system 200 configured to implement an ad proxy service, in accordance with certain embodiments of the present disclosure. In particular, FIG. 2 depicts a sequence of operations and data transfers between a client device 206, an ad proxy 212, and an ad server 204, which may correspond to client system 106, ad proxy 112, and ad server 104 of FIG. 1. Although not shown in FIG. 2 for the sake of clarity, information may also be exchanged between elements of system 200 and content provider service 102, or certain elements (such as ad proxy 212 or ad server 204) may be part of or managed by content provider service 102.

At 202, client device 206 may send a “prepare” request or indication to ad proxy 212 at “X” amount of time before an ad break in the content being shown via client device 206. For example, client device 206 may be showing a pre-downloaded VOD file, such as a 6-hour long MP4 file. The VOD file may be accompanied by metadata indicating where ad breaks should be inserted during play, or indications on when the client device 206 should issue “prepare” and “fetch” notifications to prepare for an ad break. Indications on when or where to insert an ad may also be embedded within a video file itself, or as SCTE-35 markers in an HLS stream. The client system 206 may also download or receive a configuration file (e.g., from content provider service 102), which may define when ad breaks will occur, or when to issue prepare and fetch requests, for each channel or video file of content. As an example, if an ad break is scheduled for ten minutes into a VOD file, the client system 106 may issue the prepare request at the eight minute mark, two minutes prior to the ad break (so “X” time=two minutes). The prepare request may direct the ad server 212 to negotiate or determine advertisements for the client system 206 to play during the ad break. The prepare request may also include metadata about the client system 206 or an associated user or client. Metadata may include a device identifier (ID), addressing information, geographic location, venue type, time of data, media content channel or category being played, or other details which may be used by the ad server 212 to determine what type of ads to gather and negotiate them for the client system 206.

At 208, ad proxy 212 may obtain additional client metadata, for example from a database accessible by the ad proxy 212, from a client provider service 102 that maintains details regarding clients, or from other resources. For example, the client device 206 may not maintain details about a type of venue, a geographic location, or a category of content being shown, but such details may be available from content provider service 102.

At 210, the ad proxy 212 may determine a number of ads to obtain, and may further determine what ad servers 204 to offer the ad slots to, and in what priority. For example, the ad proxy 212 may be configured to show 2.3 ads during an ad break at the current time of day, and may randomly determine to show either two ads (70% of the time) or three ads (30% of the time). At a different time of day, the number of ads may be adjusted to 2.8, as an example. In some embodiments, the ad server 212 may determine that two ads should be shown from a first ad server, one ad from a second ad server, and one “house” ad from the venue in which the client 206 is located. In another example, the ad slots may be filled based on which ad servers provide a successful bid during a prioritized bidding opportunity schedule. Ad servers may allow advertisers to bid on ad slots in real time, and in some cases no valid bids will be received when an ad server is polled. Accordingly, the ad server 212 may fill the determined number of ad slots based on whichever valid bids are received first, based on offers made to different ad servers 204 in a selected order. For example, the ad server 212 may offer two bidding opportunities to Ad Server 1, followed by three bidding opportunities to Ad Server 2, followed by two more bidding opportunities to Ad Server 1, with a failover to a house ads ad server if an insufficient number of bids are received. Bidding opportunities may be provided in any desired order to different ad servers, with the ad proxy 212 configured to end bidding opportunities when all ad slots are filled, an allotted bidding time has expired, when the client 206 issues a “fetch” request, or when an end of the bidding priority list has been reached.

At 214, once the number of ads and the priority of ad servers has been determined, the ad proxy 212 may issue requests or bidding opportunities to the determined ad server(s) to reach the determined number of ads. As part of the request, or alternately if an agreement on an ad is reached between the ad proxy 212 and ad server 204, the ad proxy 212 may provide certain client metadata to the ad server 204. For example, a client device 206 identifier may be provided, so that the ad server can recognize when the proper client device 206 attempts to access the negotiated ad, and authorize the access.

At 216, the ad server 204 may respect to the ad request or bidding opportunity with details on a selected ad, including how to access the ad (e.g., a network address and potentially access credentials), advertising campaign information, play tracking details, or other information. For example, proof of play tracking information may be reported by a client device 206 when 25%, 50%, 75%, and 100% of an ad has played, for purposes of payment for the ad being fully displayed.

At 218, the client device 206 may issue a “fetch” request to the ad proxy 212, at a time period “Y” before the ad break. The fetch request may include a request to receive the list of ads that had been gathered by the ad proxy 212, so that the client device 206 has time to download or retrieve the actual content of the ads (e.g., a video file). Similar to the time “X” described above for the prepare request, the time “Y” may identified in a configuration file or metadata for the media content, either as an absolute point in the video file at which to issue the request, or as an amount of time prior to the scheduled ad break. Returning to the previous example, if the ad break is scheduled at ten minutes into a video file, and the time “X” is two minutes prior (at eight minutes), the time “Y” may be set as one minute prior to the ad break (at nine minutes into the video).

At 220, the ad proxy 212 may respond to the fetch request by providing the compiled ad list, which may include access and tracking details for each ad. The ad proxy 212 may store ad information to a data structure (such as a Redis cache) as each ad is negotiated or identified with the ad server 204. The ad proxy 212 may then provide that data structure or another list identifying the ads to the client system 206.

At 222, based on the ad access information received from the ad proxy 212, the client device 206 may request the ad content from one or more ad servers 204. For example, the client device 206 may use a network address or link to access a video file for an advertisement, and may provide a device ID for the client device 206, or other authentication information (e.g., a security key, pin, password, or other credentials), to verify that the client device 206 is accessing the advertisement negotiated between the ad proxy 212 and the ad server 204.

At 224, the ad server 204 may provide the ad content to the client device 206. At 226, the client device 206 may play the ads once the ad break has been reached. For example, at a specified ad break time, the client device 206 may pause the media content file or stream, and play the ads negotiated by the ad proxy 212 and obtained from the ad servers 204. Once the ads have finished playing, the client device 206 may resume the media content file or stream.

At 228, the client device 206 may send ad analytics during or after playback of the ads. The ad analytics may include proof of playback information, any client engagement at the client device if appropriate, or other analytics information. The analytics information may be sent to the ad proxy 212, the ad server 204, the content provider service 102, or any combination thereof. For example, the various parties involved in the negotiation and payment for advertising may all wish to receive playback evidence for settling any advertising payments.

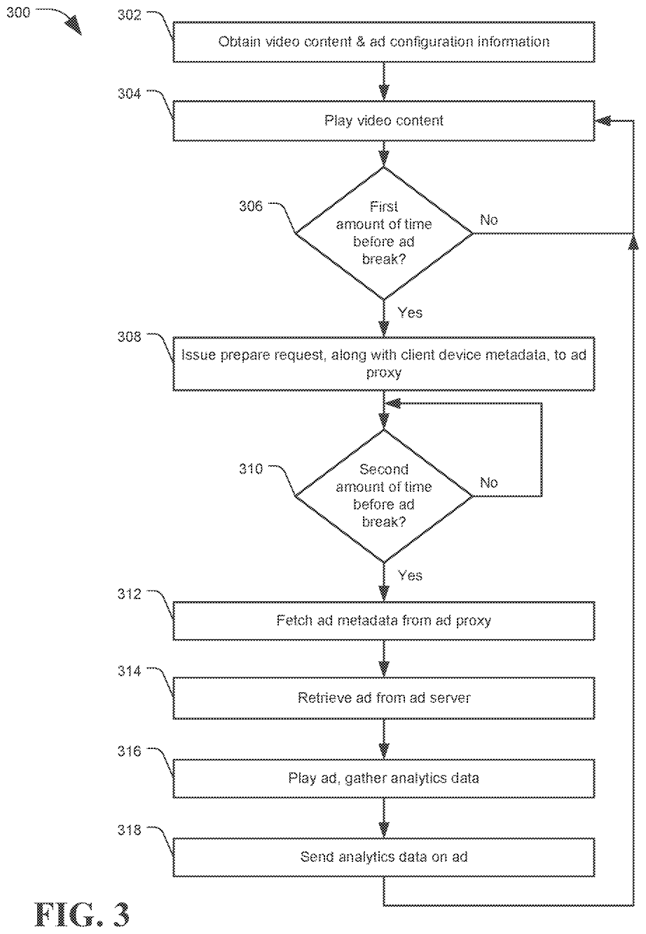

Turning now to FIG. 3, a flowchart 300 of an example method for implementing an ad proxy service is shown, in accordance with certain embodiments of the present disclosure. In particular, FIG. 3 may depict an example method for requesting, receiving, and reporting ad content at a client device. The method may be implemented by a client system, such as client system 106 of FIG. 1 or client device 206 of FIG. 2.

The method may include obtaining video content and ad configuration information, at 302. The video content may include a video on demand (VOD) downloaded file (e.g., an MP4 video file), an HTTP livestream (HLS) video feed or other over the top (OTT) content, or other audio or video content. In some examples, multiple pieces of video content may be obtained, such as different video content for each channel of a plurality of OTT channels. Ad configuration information may be instructions or code directing the client system to implement ad breaks at certain points in the video content, at certain time intervals, or at other points. The ad configuration information may direct the client system to content a specified ad proxy server at specified or selected times prior to an ad break, for issuing prepare and fetch requests from the client system to the ad proxy. The ad configuration information may also provide instructions on how the client system should convert or play ad files, report proof of play information, or otherwise handle ad content. Both the video content and ad configuration information may be obtained from the same source (e.g., a content provider service 102), or may be obtained from different sources (e.g., the video content from content provider service 102 and the ad configuration information from ad proxy 112).

At 304, the method may include playing the video content. The video content file or stream may be displayed on a screen or monitor of the client system, or connected to the client system. The client system may continue playing the video content until the ad break is reached, including during following steps of determining and sending prepare and fetch requests.

A determination may be made whether a first amount of time before a scheduled ad break has been reached, at 306. For example, the ad configuration information may indicate that an ad break is scheduled at the ten minute mark of the video content, and that a prepare request should be issued two minutes earlier, or at the eight minute mark. If the first amount of time before the ad break has not been reached, the method may include continuing to play the video content, at 304.

Once the first amount of time before the ad break has been reached, the method may include issuing a prepare request, and potentially providing client system metadata, to an ad proxy server or system, at 308. The prepare request may be an indication, instruction, or code directing the ad server to gather a selection of advertisements for the client system to display during an upcoming ad break. The metadata may include information about the client system or an associated client or account, such as a device ID, account ID, device addressing information, or other details that may be used to link and direct messages and advertising information between ad proxy systems, ad servers, content provider services, and client systems. The metadata may also include details such as a geographic location of the client system, a venue type at which the client system is set up, a time of day, preferred advertising categories, appropriate age ranges for selected advertisements, the type of content of the displayed channel or video content, or other details that an ad proxy may use to select advertisements.

At 310, the method may include determining whether a second amount of time before the ad break has been reached. The second amount of time may be shorter, or closer to the ad break, than the first amount of time from 306. In an example, if the ad break is scheduled at ten minutes into the video content, the second amount of time may be nine minutes into the video content, or one minute before the ad break. The time between the sending the prepare request at the first amount of time and sending a fetch request at the second amount of time may be configured or selected to provide the ad proxy sufficient time to arrange for the advertisements to play during the ad break. If the second amount of time has not been reached, the method may include continuing to play the video content while monitoring for the second amount of time.

When the second amount of time before the ad break has been reached, the method may include issuing a fetch request to the ad proxy, or otherwise retrieving ad content from the ad proxy, at 312. For example, the client system may send the ad proxy a fetch request, and the ad proxy may respond by sending one or more files identifying a selection of one or more ads. In another example, the ad proxy may store the ad information to a memory location accessible by the client system, so that the client system can directly retrieve the ad information from the memory. The ad metadata may include a list of the ads or digital signage to display, information on how to access or retrieve the actual ad content (e.g., a network address for a video file), information on creative and campaign IDs that may be tied to the ads, proof of play tracking information, or other details. The ad metadata may be provided by the ad proxy to the client system in a standardized format recognized by the client system, even if individual ad servers provide ad results to the ad proxy in different formats. In some examples, the ad proxy may provide the actual ad content (e.g., video, images, audio) for some or all of the ads in addition to ad metadata.

At 314, the method may include retrieving the ad content from an ad server. While the ad proxy may provide ad metadata, and actual ad content or assets directly to the client system, in other instances the client system may use the ad metadata to locate and retrieve ad content from an ad server. For example, the ad server may use the client system ID when negotiating an ad, and then provide the client system with a network link to the ad assets. The client system may provide its client system ID via the network link to verify its identity and receive authorization to obtain the advertisement assets.

The method may include playing the ad, at 316. The ad may be played or displayed during a scheduled ad break, or may be played or displayed immediately upon receipt. If the ad is played during a scheduled ad break, the client system may download or cache the ad locally, and wait until the ad break is reached before playing the ad. In some examples, the ad may be streamed live during the ad break, rather than downloaded. If multiple ads are to be played during the ad break, a first ad may be played while a second or subsequent ad are still being downloaded or accessed. While playing the ad, the client system may track proof of play information or other analytics data. For example, some advertisements may enable customer feedback or interaction, and the system may monitor whether any interaction is detected. Analytics information may also include what time the ads were displayed, how often, or other information. For example, the client system may cache or store ads, and may play them during multiple ad breaks as part of the negotiated advertising arrangement negotiated by the ad proxy.

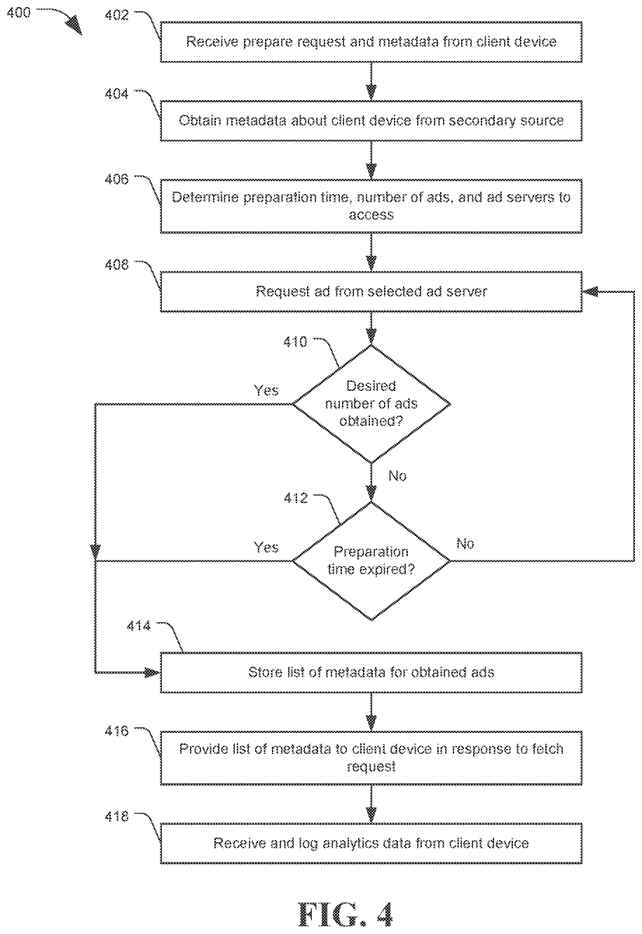

At 318, the method may include sending analytics data on the ads that have been played. Analytics data may be sent to one or more entities or systems, including an ad server, ad proxy, content provider service, another recipient, or any combination thereof. Analytics data may be sent during the ad playback (e.g., to provide updates on what percentage of the ad has been played), or after the ad (either immediately upon completion of the ad, or at a later point, such as once the ad has been played a selected number of times). The method may then return to 304, and resume playing the video content once the ad break has concluded, and monitoring for when to send prepare and fetch requests for a next ad break. Another example method of implementing an ad proxy service, from the perspective of the ad proxy system, is described in regard to FIG. 4.

FIG. 4 depicts a flowchart 400 of an example method for implementing an ad proxy service, in accordance with certain embodiments of the present disclosure. In particular, FIG. 4 may depict an example method for negotiating and preparing one or more ads for display at a client system. The method may be implemented by an ad proxy system, such as ad proxy 112 of FIG. 1 or 212 of FIG. 2.

The method may include receiving a prepare request and metadata from a client device, at 402. The prepare request and metadata may correspond to those discussed in regard to element 308 of FIG. 3. Based on identifying information for the client device, the method may also include obtaining additional metadata about the client device from a secondary source, at 404. For example, the client device or its associated customer may have an account with a content provider service (such as content provider service 102 of FIG. 1), and the method may include accessing details about the client device or customer from that source. Client preferences, viewing history, or other information may be available from the secondary source that are not available from the client device directly. The metadata from the client device and secondary sources may be used in selecting appropriate advertisements.

At 406, the method may include determining preparation time, a number of ads, and ad servers to access or negotiate with to prepare a set of ads for display at the client system.

An amount of preparation time may refer to how much time the ad server has to gather the ads. In some examples, the ad server may be configured with a default preparation time, or the client system may provide an indication of preparation time along with the prepare request.

The ad server may determine a number of ad requests or bidding opportunities it can submit to ad servers based on the preparation time. The determination of the number of ads may refer to how many ads the ad server will attempt to gather for the upcoming ad break. This number may be preconfigured, proposed by the client system, or otherwise determined. The number may be a whole number (e.g., 2, 3, 4, etc.), or it may be a decimal or fractional number with a whole number of ads selected randomly based on the decimal (e.g., 2.7 ads may result in two ads 30% of the time, or three ads 70% of the time), or the number may be otherwise determined. The number of ads may change based on factors such as the time of day or how busy a venue is.

Which ad servers to access, and in what order, may be part of a mediation process implemented by the ad server. For example, different types of ad servers may be given an opportunity to bid on ad slots, but must be offered the opportunities separately (e.g., if different types of ad servers are not configured to bid against each other) and one-at-a-time (e.g., to avoid simultaneous bids on a single slot). Accordingly, the ad server may determine how many bidding opportunities to provide to which ad servers, and in which order. Further, based on client factors such as content preference, venue type, customer age range, video content channel or type, or other factors, certain ad categories or servers may be more appropriate than others. Accordingly, the ad proxy may use client metadata, preconfigured ad server priorities, or other factors to generate an order or priority in which to access one or more ad servers. As explained above, bidding on ad slots may be performed in real time, and providing a bidding opportunity to an ad server may not result in any accepted bids on any given access, but may result in a valid bid on a next access. Therefore, the access priorities may include offering ad server 1 three consecutive bidding opportunities, followed by providing ad server 2 five consecutive bidding opportunities. Failover options, such as selecting a house ad for the client if an insufficient number of third party ads are acquires, may also be factored into the ad server's process.

At 410, a determination may be made whether the desired number of ads has been obtained. If yes, the ads may be stored or consolidated in data structure, such as a list of ads to play in the ad break and corresponding metadata, at 414. The ad metadata may correspond to the metadata discussed in regard to element 312 of FIG. 3.

If the desired number of ads is not yet obtained, at 410, a determination may be made whether the preparation time has expired, or if the client system has issued a fetch request to collect the ads, at 412. If not, the method may include making another attempt to acquire an advertisement, at 408. If the preparation time has expired or a fetch request received, the method may include generating the list of successfully acquired ads, at 414. If the desired number of ads was not acquired, the system may employ a failover option, such as retrieving one or more house ads for the client, which may not require a negotiation or bidding process, and adding those ads to the list. The method may include providing the list of ad metadata to the client device in response to a fetch request, at 416.

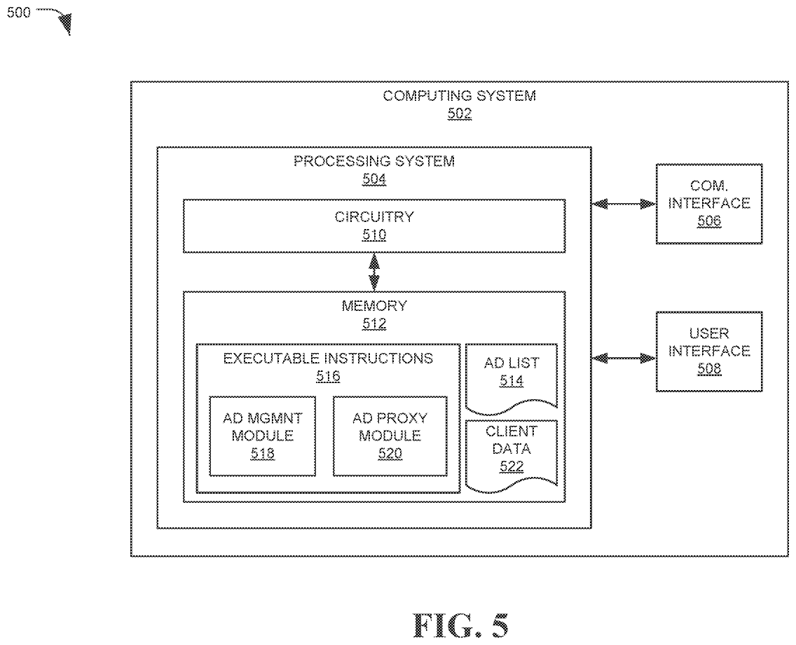

At 418, the method may include receiving and logging analytics data from the client device. The analytics data may be used to verify that the ads that were negotiated were the same ones that were played by the client device, how much of each ad was played, or any other feedback. The analytics data may be used to ensure that proper payment is exchanged between the ad server (or ad creator) and the ad proxy, content provider service, or client associated with the client device. An example computing system for implementing an ad proxy system is described in regard to FIG. 5.

FIG. 5 is a diagram of a system 500 configured to implement an ad proxy service, in accordance with certain embodiments of the present disclosure. In particular, FIG. 5 depicts a computer system 502, which may be an example of any computing system that may be employed to perform the operations of content provider service 102, ad server 104, client system 106 or ad management module 108, ad proxy 112, and related processes and methods. Computing system 502 may include a processing system 504, a communication interface 506, and a user interface 508. Computing system 502 may include other components, such as a battery and enclosure, that are not shown for clarity. Computing system 502 may comprise one or more server computing systems, desktop computing systems, laptop computing systems, smartphone devices, set-top or streaming boxes, connected televisions, or any other computing system, including combinations thereof.

Communication interface 506 may comprise components that communicate over communication links, such as network cards, ports, radio frequency (RF), processing circuitry and software, or other communication components. Communication interface 506 may be configured to communicate over metallic, wireless, or optical links. Communication interface 506 may be configured to use Time Division Multiplex (TDM), Internet Protocol (IP), Ethernet, optical networking, wireless protocols, communication signaling, other communication formats, or any combinations thereof. In particular, communication interface 506 may be configured to communicate over a network 110 with content provider service 102, client systems 106, ad servers 104, ad proxy 112, or other external systems. Communication interface 506 may also enable communication with local external devices, such as external storage or interface devices.

User interface 508 may comprise components that interact with a user to receive user inputs and to present media or other information. User interface 508 may include a display screen, touch screen, touch pad, keyboard, buttons, speaker, microphone, pointer device or interface, communication port, other user input/output apparatus, or any combination thereof. In some examples, user interface 508 may be a module configured to interface with a separate system for presenting information and receiving inputs. For example, computing system 502 may have limited or no direct user input components, but it connects (e.g., via communication interface 506) to a monitor or other device that may receive inputs via touch screen, remote control, or other input method, which inputs are then provided or relayed to computing system 502.

Processing system 504 may be linked to communication interface 506 and user interface 508. Processing system 504 can include processing circuitry 510 and memory device 512. Memory device 512 can store executable instructions or other operating software 516, as well as non-executable data files, such as an ad list 514, and client data 522.

Processing circuitry 510 may comprise a microprocessor and other circuitry that can retrieve and execute instructions 516 from memory device 512. Memory 512 may comprise a non-volatile data storage medium, such as a disk drive or solid state drive, or volatile memory such as random access memories (RAM) and dynamic RAM (DRAM), or any other memory apparatus. In some examples, processing circuitry 510 may be mounted on a circuit board that may also hold memory device 512 and portions of communication interface 506 or user interface 508.

Executable instructions 516 may comprise computer programs, firmware, or some other form of machine-readable processing instructions. Executable instructions 516 may include ad management module 518, and ad proxy module 520, although related operations may be handled by multiple different modules or programs (potentially located on multiple computing devices), all operations may be performed by a single module, or additional modules may be included in executable instructions 516. For example, embodiments of ad management module 518 and ad proxy module 520 may be implemented by content provider service 102, client system 106 or ad management module 108, ad server 104, ad proxy 112, other systems, or a combination thereof. Executable instructions 516 may further include an operating system, utilities, drivers, network interfaces, applications, or other types of software. When executed by processing circuitry 510, executable instructions 516 may direct processing system 504 to operate computing system 502 as described herein.

Ad management module 518 may be a set of instructions for preparing for or executing ad breaks for a client system 106. An ad management module 518 located at a client system 106 may be configured to obtain ad configuration information (e.g., from content provider service 102, or as metadata of a video file), determine timing for sending prepare and fetch requests to an ad server 112, obtaining ad assets, presenting advertisements at an ad break of a media content video or stream, and monitoring and reporting analytics data for an ad. At other systems, such as a content provider service 102, ad server 104, or ad proxy 112, an ad management module 518 may generate or provide ad configuration information to a client system 106, transmit ad content or metadata, or otherwise prepare for the preparation or play of ads at a client system 106.

Ad proxy module 520 may include a set of computer functions, instructions, or access details for performing ad proxy services or operations. For example, ad proxy module 520 may be configured to negotiate with ad servers 104 for advertisements to present at a client system 106, including making a list data structure 514 of ads and associated metadata. The ad proxy module 520 obtain client data or metadata 522 from client system 106, content provider service 102, or other sources. Further, the ad proxy module 520 may determine a number of ads to display, which ad servers 104 to negotiate with and in which order, and content or types of ads to negotiate for, for example based on client preferences or data 522.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Steps depicted in the flowcharts may optionally be excluded, added, performed in a different order, or performed with different degrees of concurrency than shown (e.g., steps depicted as sequential may be performed concurrently). Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

1. A method comprising:
performing an ad proxy service at an ad proxy server, including:
receiving a prepare request, from a client device, to prepare an advertisement for display during an ad break in content playing at the client device;
obtaining client metadata regarding the client device;
negotiating the advertisement with an ad server by obtaining ad metadata; and
providing the ad metadata to the client device.

2. The method of claim 1 further comprising selecting an ad server, from a plurality of ad servers, to negotiate the advertisement with.

3. The method of claim 2 further comprising selecting the ad server based on the client metadata.

4. The method of claim 2 further comprising:
determining a selected number of ads to negotiate for the ad break; and
negotiating the selected number of ads by obtaining the ad metadata for the selected number of ads.

5. The method of claim 4 further comprising:
storing the ad metadata for the selected number of ads to a list data structure; and
providing the list data structure to the client device.

6. The method of claim 5 further comprising:
receiving a fetch request from the client device to retrieve the list data structure; and
providing the list data structure in response to the fetch request.

7. The method of claim 6 further comprising:
selecting multiple ad servers, from the plurality of ad servers, to negotiate the selected number of ads with; and
determining a prioritized bidding opportunity schedule to establish which order to contact the multiple ad servers to offer opportunities to bid on the selected number of ad slots.

8. The method of claim 7 further comprising:
determining, in response to the prepare request, a preparation time in which to negotiate the selected number of ads; and
finalizing the list data structure when any of the following events occur: the selected number of ads have been negotiated, the preparation time has expired, and the fetch request has been received.

9. The method of claim 1 further comprising:
logging analytics data received from the client device regarding playback of the advertisement.

10. A system comprising:
an ad proxy server configured to perform an ad proxy service, including:
receive a prepare request, from a client device, to prepare an advertisement for display during an ad break in content playing at the client device;
obtain client metadata regarding the client device;
negotiate the advertisement with an ad server by obtaining ad metadata; and
provide the ad metadata to the client device.

11. The system of claim 10 comprising the ad proxy server further configured to:
negotiate the advertisement based on the content of the advertisement and the client metadata.

12. The system of claim 10 comprising the ad proxy server further configured to:
determine a selected number of ads to negotiate for the ad break;
negotiate the selected number of ads by obtaining the ad metadata for the selected number of ads;
store the ad metadata for the selected number of ads to a list data structure; and
provide the list data structure to the client device.

13. The system of claim 12 comprising the ad proxy server further configured to:
select multiple ad servers, from a plurality of ad servers, to negotiate the selected number of ads with; and
determine a prioritized bidding opportunity schedule to establish which order to contact the multiple ad servers to offer opportunities to bid on the selected number of ad slots.

14. The system of claim 10 comprising the ad proxy server further configured to:
determine, in response to the prepare request, a preparation time in which to negotiate the advertisement;
monitor for
1) an expiration of the preparation time, and
2) receipt of a fetch request from the client device, directing the ad proxy server to provide the ad metadata to the client device, with detection of either acting as a trigger to finalize the ad metadata to provide to the client device; and
provide the ad metadata to the client device in response to the fetch request.

15. The system of claim 10 further comprising:
the client device configured to obtain the advertisement for display during the ad break in the content, including:
obtain ad configuration information regarding the content;
send the prepare request to the ad proxy server at a first time prior to the ad break;
send a fetch request to the ad proxy server at a second time prior to the ad break, the fetch request directing the ad proxy server to provide the ad metadata corresponding to the advertisement to the client device;
obtain the advertisement based on the ad metadata; and
display the advertisement during the ad break.

16. A memory device storing instructions that, when executed, cause a processor to perform a method comprising:
obtaining, at a client device from an ad proxy service, an advertisement for display during an ad break in content playing at the client device, including:
obtaining ad configuration information regarding the content;
sending a prepare request to the ad proxy service at a first time prior to the ad break, the prepare request directing the ad proxy service to prepare the advertisement;
sending a fetch request to the ad proxy service at a second time prior to the ad break, the fetch request directing the ad proxy service to provide ad metadata corresponding to the advertisement to the client device;
obtaining the advertisement based on the ad metadata; and
displaying the advertisement during the ad break.

17. The memory device of claim 16 storing instructions that, when executed, cause the processor to perform the method further comprising:
accessing the advertisement from an ad server based on the ad metadata, wherein the ad metadata includes a network address for the advertisement.

18. The memory device of claim 17 storing instructions that, when executed, cause the processor to perform the method further comprising:
sending client system metadata to the ad proxy service along with the prepare request.

19. The memory device of claim 18 storing instructions that, when executed, cause the processor to perform the method further comprising:
the client system metadata includes uniquely identifying information associated with the client device; and
accessing the advertisement from the ad server based on the uniquely identifying information and the ad metadata.

20. The memory device of claim 16 storing instructions that, when executed, cause the processor to perform the method further comprising:
obtaining analytics data corresponding to display of the advertisement during the ad break; and
transmitting the analytics data to a remote system.
